(19) United States
(12) Patent Application Publication
(10) Pub. No.: US 2014/0055337 A1
(43) Pub. Date: Feb. 27, 2014

(54) DEVICE EYE TRACKING CALIBRATION

(71) Applicant: Kent Karlsson, Berkeley, CA (US)

(72) Inventor: Kent Karlsson, Berkeley, CA (US)

(73) Assignee: MobiTV, Inc., Emeryville, CA (US)

(21) Appl. No.: 13/591,481

(22) Filed: Aug. 22, 2012

(51) Int. Cl. G06F 3/01

(52) U.S. Cl. 345/156

(57) ABSTRACT

Described herein are techniques and mechanisms for device eye tracking calibration. According to various embodiments, a user interface activation screen for activating a user interface may be presented at a computing device. The user interface activation screen may include an eye tracking calibration affordance configured for calibrating eye tracking at the computing device. The eye tracking calibration affordance may be displayed at a designated location on the user interface activation screen. Eye tracking information may be received via an optical sensor at the computing device. The eye tracking information may describe a state of one or both eyes of an individual located proximate to the computing device during activation of the affordance. The eye tracking information may be compared with the designated location to calibrate eye tracking at the computing device. The user interface may be activated.

### TECHNICAL FIELD

The present disclosure relates generally to calibrating a device for eye tracking.

### DESCRIPTION OF RELATED ART

Eye tracking may be performed for a variety of purposes at consumer devices. For instance, eye tracking may be performed to estimate user preferences, to allow a user to navigate a user interface, to identify content portions for increasing or decreasing a level of detail, or for any other reasons. Before eye tracking is conducted, eye tracking procedures and systems are often calibrated. Eye tracking calibration may involve matching eye tracking data received by an optical sensor with the actual movements of an individual's eyes.

### BRIEF DESCRIPTION OF THE DRAWINGS

The disclosure may best be understood by reference to the following description taken in conjunction with the accompanying drawings, which illustrate particular embodiments.

FIG. 1 illustrates one example of a method for performing eye tracking for a computing device.

FIG. 2 illustrates one example of a system that can be used with various techniques and mechanisms of the present invention.

FIG. 3 illustrates one example of a method for calibrating eye tracking during activation of an interface.

FIG. 4 illustrates one example of a method for transmitting an eye tracking calibration interface to a client machine.

FIGS. 5 and 6 illustrate examples of media delivery systems.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of fragments, particular servers and encoding mechanisms. However, it should be noted that the techniques of the present invention apply to a wide variety of different fragments, segments, servers and encoding mechanisms. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

Before eye tracking is conducted, eye tracking procedures and systems are often calibrated. Eye tracking calibration may involve matching eye tracking data received by an optical sensor with the actual movements of an individual's eyes. According to various embodiments, eye tracking calibration may be incorporated into the startup procedure for an interface such as a device operating system, an application, or a webpage. By incorporating eye tracking calibration into a startup procedure, eye tracking calibration may be performed seamlessly without requiring the user to perform a separate calibration procedure. Thus, the quality of eye tracking may be improved without requiring additional time or effort from a user.

### Example Embodiments

According to various embodiments, incorporating eye tracking calibration into the startup procedure of an application or user interface may be used to calibrate eye tracking without requiring a separate calibration step after the interface is initiated. For example, the startup procedure for a website may require the user to activate a button to agree to particular terms or conditions of using the website. Instead of clicking on the button with a mouse or touch screen, the user may be asked to gaze at the button. Thus, eye tracking calibration may be incorporated into the startup procedure without requiring that the user perform a separate calibration procedure.

According to various embodiments, performing eye tracking calibration for a particular device may be used to reflect eye movement differences between different devices. For instance, when a user accesses an electronic program guide on a mobile phone, the user's eye movements may be different than when the user accesses the same program guide on a laptop computer. By incorporating eye tracking calibration into the application or user interface startup process, the calibration may be performed for the specific device being operated by the user.

According to various embodiments, performing eye tracking calibration at the startup of an application or user interface may be used to ensure that eye tracking is calibrated for a particular user. For instance, more than one user may be associated with a particular device such as a television, computer, or mobile device. By incorporating eye tracking calibration into the application or user interface startup process, the calibration may be performed for the user using the device when the user interface or application is started.

According to various embodiments, performing eye tracking calibration at the startup of an application or user interface may be used to ensure that eye tracking is calibrated for a specific use. For instance, user eye movements during use of a website displayed in a web browser may be different than user eye movements during use of an electronic program guide. By incorporating eye tracking calibration into an application or user interface startup process, the effects of these differences on eye tracking may be reduced.

Eye tracking information of a user proximate to the client machine is identified. According to various embodiments, the eye tracking information may be identified by use of an optical sensor. The optical sensor may be used to determine location, orientation, and movement information for the user's eyes or other facial features.

According to various embodiments, various types of eye tracking information may be monitored. The eye tracking information that may be monitored and processed may include, but is not limited to: user eye movement velocity and acceleration, the location at which a user is gazing, the duration or “dwell” of a user's gaze at a particular location or locations, a blink frequency, the dilation of a user's pupils, the eyelid aperture size, and/or other eye-related information. Also, the eye tracking information may include data used to identify a user's facial expressions or other indications of a user's mood, opinion, or impressions when viewing content presented on a portion of the display screen. Accordingly, although the information may be referred to herein as “eye tracking information”, in some instances this information may include data regarding the user's facial movements, head location, head orientation, or other such related information.

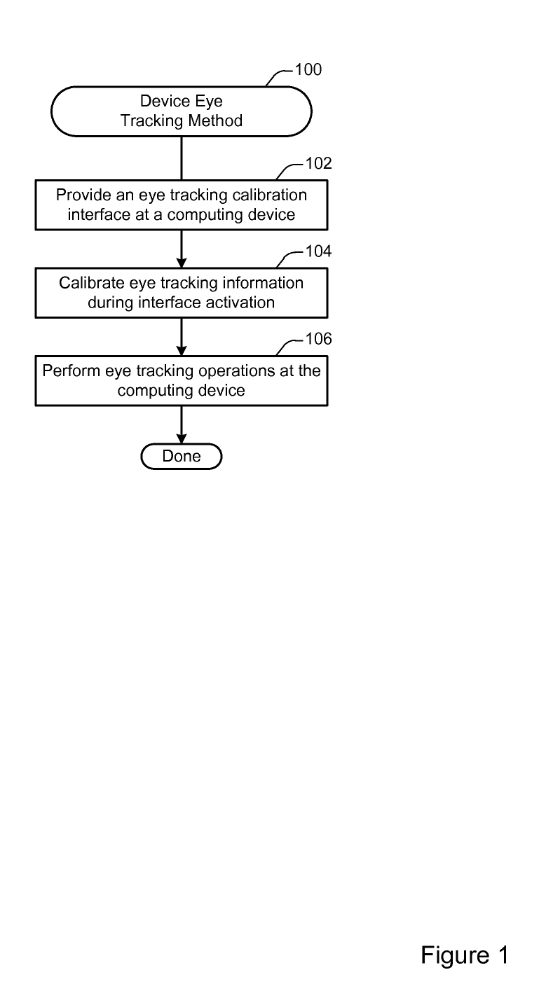

FIG. 1 illustrates one example of a method 100 for performing eye tracking calibration for a computing device. According to various embodiments, eye tracking calibration may be performed to facilitate accurate eye tracking. When an interface is activated, an eye tracking calibration interface is presented to the user as part of the activation process. Then, the eye tracking may be performed after the interface is activated.

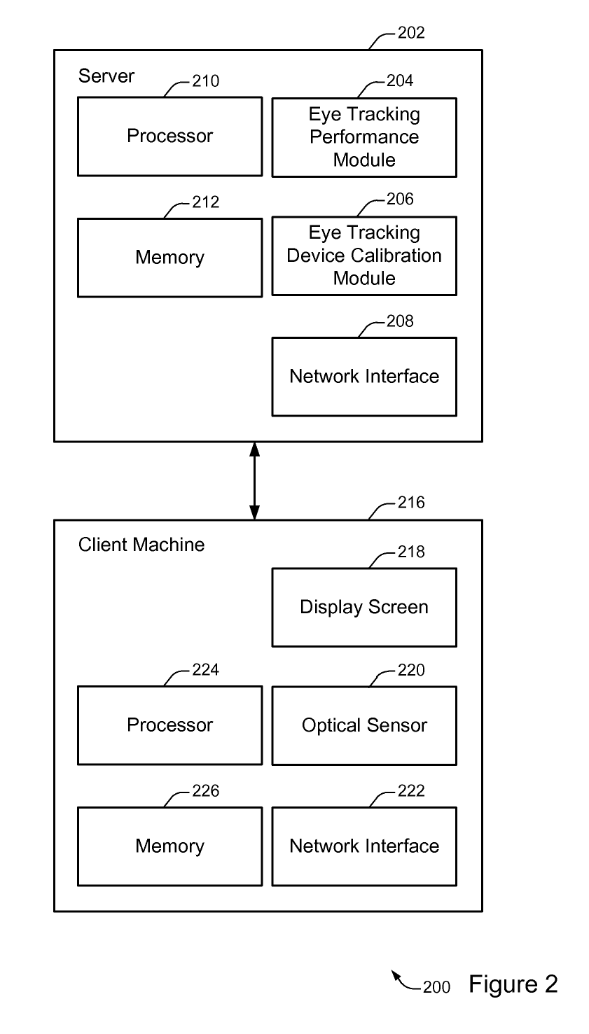

According to various embodiments, the method 100 may be performed at a computing device that has an optical sensor capable of detecting information for eye tracking. For instance, the eye tracking calibration may be performed at a laptop computer, desktop computer, tablet computer, mobile phone, or television in communication with a camera. An example of such a computing device is described in additional detail with respect to FIG. 2.

At 102, an eye tracking calibration interface is provided at a computing device. According to various embodiments, an eye tracking calibration interface may be any configuration of a display screen for performing eye tracking during the startup of an operating system, webpage, application, or other user interface. For instance, an eye tracking calibration interface may designate one or more areas of the display screen as calibration areas. The eye tracking calibration interface may also include a message requesting the user to gaze at the calibration areas in order to calibrate eye tracking at the device.

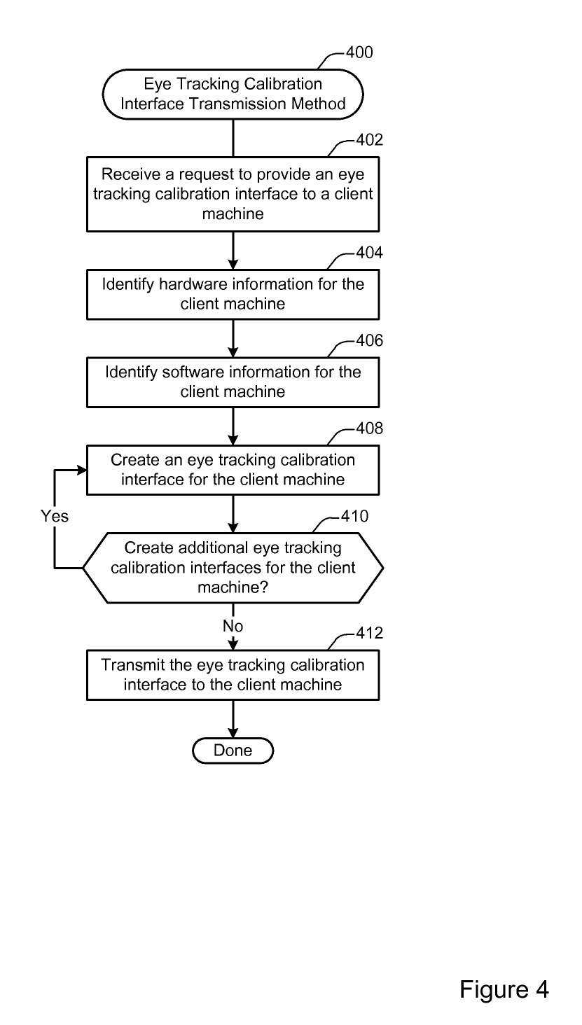

According to various embodiments, the eye tracking calibration interface may be provided to the computing device in various ways. For example, the eye tracking calibration interface may be integrated with an operating system installed on the computing device. As another example, the eye tracking calibration interface may be downloaded from a server as a standalone application or as part of a larger application. As yet another example, the eye tracking calibration interface may be integrated into a webpage provided by a web server to a web browser running at the computing device. Examples of techniques for providing an eye tracking calibration interface are discussed in additional detail with respect to FIG. 4.

At 104, eye tracking information is calibrated during activation of an interface. According to various embodiments, the interface may be an operating system associated with the device, a webpage loaded in a web browser displayed on the device, a content management interface, an electronic program guide, an application, or any other digital system by which a user may interact with the device.

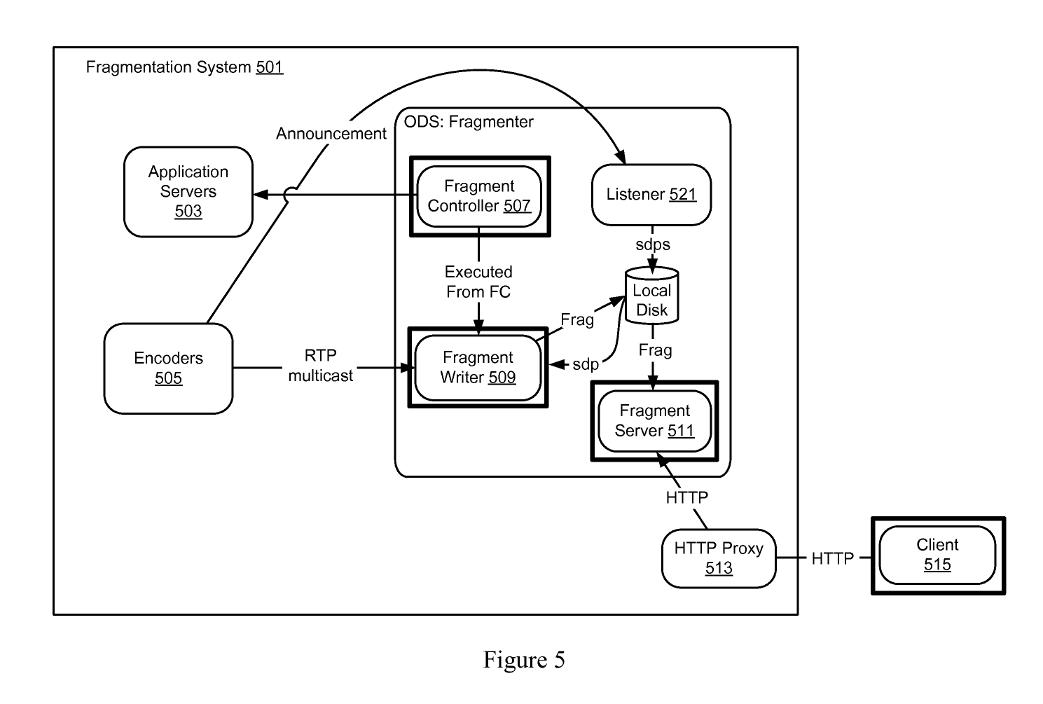

According to various embodiments, the eye tracking information may be calibrated by presenting the eye tracking calibration interface as part of the interface activation process. For instance, a user may activate one or more digital buttons located on a display screen by gazing at the button. The locations of the buttons may be matched with eye tracking information collected for the user's eyes while the user is gazing at the buttons. Then, when the user is looking at locations other than the buttons, the calibration information may be used to identify a screen location on which the user is focused. Examples of techniques for calibrating eye tracking at a computing device are discussed in additional detail with respect to FIG. 5.

At 106, eye tracking operations are performed at the client machine. According to various embodiments, eye tracking operations may be performed once eye tracking is calibrated. Eye tracking may be performed for a variety of reasons and in conjunction with a variety of applications or operations.

In particular embodiments, eye tracking may be used to determine user preferences. For instance, eye tracking may be performed to identify content items presented in a digital content guide that are focused on by a user. In some cases, gazing at a particular content item may indicate a preference for the item, while not gazing at a particular content item may indicate a lack of interest in the item. User preferences inferred from eye tracking information may be used to provide customized content to a user. For example, a system may transmit a customized electronic program guide that includes content items selected to correspond with an estimate of a user's preferences. Calibrating the system for eye tracking may help ensure that the content that the user has focused on is properly detected.

In particular embodiments, eye tracking information may be monitored and tracked in the context of the presentation of video content. For instance, users' eyes may be observed to focus on a particular portion of a display screen during a particular period of time when particular video content is presented. Based on this observation, the video content may be encoded to provide for differential treatment of different portions of the content. For example, a portion of the video content on which users' eyes are focus less may be defocused relative to other portions of the video content. Calibrating the system for eye tracking may help ensure that the portion of video content that a user has focused on is properly detected.

In particular embodiments, eye tracking information may be monitored and tracked in the context of navigating a user interface. For example, a row of buttons may be presented on the display screen. Then, a user may gaze at a particular button to select it. As another example, a user may blink his or her eyes in a designated manner to confirm a selection. As yet another example, a user may gaze to the right or left of the screen to select additional content.

FIG. 2 illustrates an example of a system 200. According to various embodiments, the system 200 may be used in conjunction with techniques described herein to collect eye tracking information and calibrate eye tracking at a computing device. The system 200 includes a server 202 and a client machine 216. The server and the client machine may communicate via a network interface 208 at the server and a network interface 222 at the client machine.

The client machine includes a processor 224 and memory 226. Additionally, the client machine includes a display screen 218 configured to display content. The client machine also includes an optical sensor 220 operable to collect eye tracking information from an individual in proximity to the client machine.

The server includes an eye tracking calibration module 206 operable to facilitate eye tracking calibration at the client machine 216. The server also includes an eye tracking performance module 204 operable to use the eye tracking calibration information to perform tasks that involve eye tracking. As well, the server includes a processor 210 and memory 212.

According to various embodiments, as described herein, a server may include components not shown in FIG. 2. For example, a server may include one or more additional processors, memory modules, storage devices, and/or communication interfaces. As another example, a server may include software and/or hardware operable to retrieve content and provide the content to client machines.

The eye tracking device calibration module 206 may be used to facilitate eye tracking calibration at one or more client machines. For example, the eye tracking device calibration module may transmit instructions to the client machine for performing an eye tracking calibration procedure. As another example, the eye tracking device calibration module may receive eye tracking data collected from the client machine and may perform the eye tracking calibration. For instance, some devices may have limited processing capabilities, and calibration processing operations may be more easily performed at the server. As yet another example, the eye tracking device calibration module may be used to store eye tracking calibration information. For instance, if the result of eye tracking calibration for a user is consistent across multiple calibration procedures, calibration may be partially or entirely omitted in the future.

According to various embodiments, the eye tracking performance module 204 is operable to perform one or more operations related to eye tracking. For instance, the eye tracking performance module 204 may analyze eye tracking information to predict user preferences, provide a user interface that may be navigated at least in part by eye movements, or perform content focusing or defocusing based on eye tracking. The eye tracking performance module 204 may use the calibration information determined by the eye tracking device calibration module 206 to ensure that an individual's eye movements are correctly interpreted.

The network interface 208 is configured to receive and transmit communications via a network such as the Internet. According to various embodiments, the network may be a wired network or a wireless network. The network interface may communicate via HTTP, TCP/IP, UDP, or any other communication protocol. Content may be transmitted to the client machine via unicast, multicast, broadcast, or any other technique. Also, content need not be transmitted by the server 202. For example, in particular embodiments the server 202 may select content for presentation, while another server may transmit the content to the client machine.

The client machine 216 may be any device operable to receive content via a network and present the content on the display screen 218. For example, the client machine 218 may be a desktop or laptop computer configured to communicate via the Internet. As another example, the client machine may be a mobile device such as a cellular phone or tablet computer configured to communicate via a wireless network.

The display screen 218 may be any type of display screen operable to present content for display. For example, the display screen may be an LCD or LED display screen. As another example, the display screen may be a touch screen. The client machine 216 may include other components not shown in FIG. 2, such as one or more speakers, additional display screens, user input devices, processors, or memory modules.

The optical sensor 220 is operable to locate and track the state of one or both eyes of an individual in proximity to the client machine. The optical sensor is configured to receive and process light received at the sensor. According to various embodiments, the light received and processed by the optical sensor may be any light on the spectrum capable, including visible light, infrared light, ultraviolet light, or any other kind of light. The specific type of light sensor used may be strategically determined based on factors such as the type of device at which the sensor is located and the likely proximity of the user to the device. In particular embodiments, the light sensor may be a digital camera. Alternately, or additionally, an infrared sensor may be used.

In particular embodiments, more than one light sensor may be used. For example, information from two light sensors may be combined to triangulate a location of an eye. As another example, different types of light sensors may be used to provide better eye tracking information in various lighting conditions.

The network interface 222 is configured to receive and transmit communications via a network such as the Internet. According to various embodiments, the network may be a wired network or a wireless network. The network interface may communicate via HTTP, TCP/IP, UDP, or any other communication protocol. Content may be received at the client machine via unicast, multicast, broadcast, or any other transmission technique.

According to various embodiments, the components shown in the client or server in FIG. 2 need not be physically located within the same machine. For example, the optical sensor 220 shown in FIG. 2 may be a web camera in communication with the client machine via an interface such as USB. As another example, the user information storage module 206 may be located outside the server 202. For instance, the user information may be stored in a network storage location in communication with the server 202 via the network interface 208.

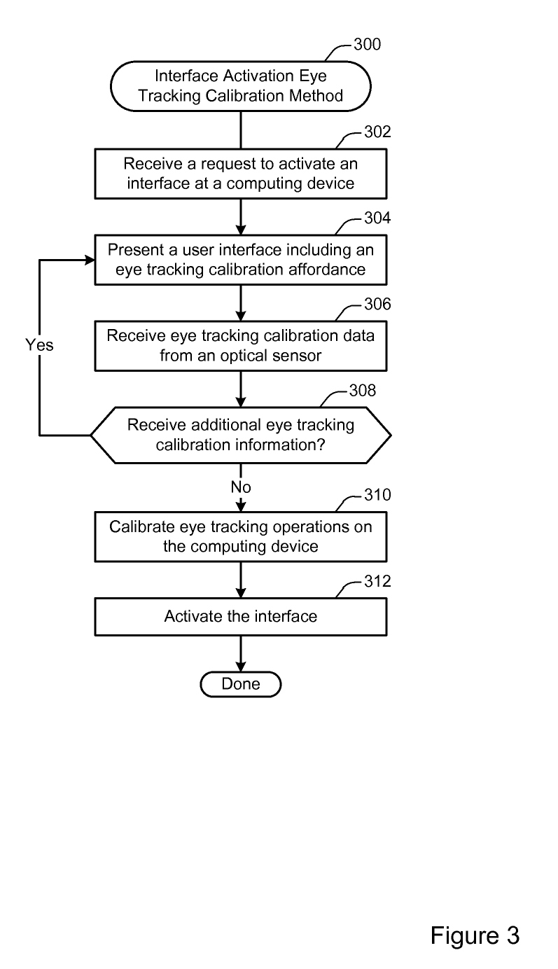

FIG. 3 illustrates one example of a method 300 for calibrating eye tracking during activation of an interface. According to various embodiments, the method 300 may be performed at a computing device having an optical sensor, as discussed with respect to FIG. 2. When an interface is activated, eye tracking calibration may be integrated into the activation process to ensure that subsequent eye tracking is accurate without necessarily requiring a separate calibration procedure.

At 302, a request is received to activate an interface at a client machine. According to various embodiments, the type of request received may depend on the type of interface being activated.

According to various embodiments, the interface may be an operating system associated with the device. In this case, the activation of the interface may be a boot up procedure for the device. Here the request may be the detection of the activation of a power button or some other triggering switch associated with the device.

According to various embodiments, the interface may be a webpage presented in a web browser. In this case, the activation of the interface may be the transmission of the web browser to the client machine and the rendering of the webpage by the web browser. Here the request may be an HTTP request transmitted to a web server configured to provide the webpage.

According to various embodiments, the interface may be an application executed on the computing device. In this case, the activation of the interface may be a startup procedure for initiating the application. Here the request may be a command to execute the application.

According to various embodiments, the interface may be a user interface displayed within an application on the computing device. For example, the computing device may be displaying a content management application such as a connected content management application capable of managing content across different devices and content presented on different devices. In this case, the interface may be a particular portion of the application, such as a user interface portion capable of being used in conjunction with eye tracking operations. Here the request may be the activation of a user interface navigation element within the application that corresponds to a request to navigate to the interface portion of the application.

According to various embodiments, eye tracking calibration may be incorporated into actions performed by the user during interface activation. For instance, the user may be required to specify options, agree to terms of use, enter a password, or perform other such operations. In such cases, the activation of the user interface may require user input provided via eye tracking, which may facilitate calibration. For example, the user may be asked to gaze at letters on an onscreen keyboard to enter a username or password. As another example, the user may be asked to gaze at an “OK” button and blink twice to confirm acceptance of terms of use. As yet another example, the user may be asked to gaze at one of a set of options to select it.

At 304, a user interface including an eye tracking calibration affordance is presented. According to various embodiments, the eye tracking calibration affordance is an instruction, designated area, or quality of the user interface that allows the user to perform an action for eye tracking calibration. Various types of eye tracking calibration affordances may be used, and the specific type or types of eye tracking calibration affordance presented may be strategically determined based on the type of eye tracking calibration being performed.

According to various embodiments, the eye tracking calibration affordance may provide an instruction to the user for performing an action to facilitate eye tracking. For example, the user may be asked to gaze to the left, right, top, and/or bottom of the display screen. As another example, the user may be asked to gaze at any or all of the four corners of the display screen or at some other location on the screen. As yet another example, the user may be asked to gaze at one or more screen locations for a designated period of time. As still another example, the user may be asked to blink a designated number of times, exhibit one or more designated facial expressions, move or tilt his or her head, open or close his or her eyes, or perform any other such operations.

According to various embodiments, the eye tracking calibration affordance may elicit involuntary action from the user. For instance, the eye tracking calibration affordance may be a bright area suddenly presented in a portion of a display screen that is otherwise rather dark. In this case, the user's eyes may be involuntarily drawn to the bright area, which may facilitate the calibration of eye location and motion tracking.

At 306, eye tracking calibration data is received from an optical sensor. According to various embodiments, the specific type of calibration data received may depend on the type of eye tracking calibration being performed. In particular embodiments, the eye tracking calibration data may identify an appearance of the user's eyes while the user is activating the eye tracking calibration affordance. For instance, the user may be gazing at designated locations on the display screen, gazing at locations off of the display screen, glancing back and forth between designated screen portions, blinking his or her eyes, or performing other such operations.

At 308, a determination is made as to whether to receive additional eye tracking calibration information. According to various embodiments, the determination as to whether to receive additional eye tracking calibration information may be made dynamically. For instance, the computing device or a remote server in communication with the computing device may determine whether the eye tracking calibration information already received is sufficient to calibrate the computing device. When the information is insufficient, additional information may be received. The information may be insufficient if it is unclear, inconsistent, or ambiguous.

According to various embodiments, the determination as to whether to receive additional eye tracking calibration information may be made statically. For instance, the calibration procedure may be configured to perform certain types of calibration operations for each user. For example, a user may be asked to gaze at each corner of the display screen for a designated period of time. As another example, a user may be asked to gaze at a confirmation button located in some area of the display screen and blink twice in succession to activate the confirmation button.

In particular embodiments, a determination at 308 that additional eye tracking information should be received may trigger additional eye tracking calibration operations after the activation of the interface. For example, if the eye tracking information identified during interface activation is sufficient for calibration, then additional calibration operations may not be needed. However, if the eye tracking information identified during interface activation is insufficient in some way, then a more complete calibration procedure may be performed after interface activation. For instance, a user may be asked to perform more numerous and/or more detailed calibration operations.

At 310, eye tracking operations on the computing device are calibrated. The specific operations performed to calibrate eye tracking operations may depend on the type of eye tracking calibration being performed. According to various embodiments, various types of eye tracking information may be calibrated. This information may include, but is not limited to: gaze location, gaze duration, eye movement, eye velocity, eye acceleration, blinking, eyelid aperture size, facial expression, head location, and head orientation.

According to various embodiments, calibrating eye tracking operations on the computing device may involve comparing eye tracking information received via one or more optical sensors with a task requested from the user. For example, if a user is asked to gaze at each corner of a display screen in succession for two seconds each, the known location of each corner of the display screen may be compared with gaze information received via the optical sensor to match each location to a particular orientation of the user's eyes. Then, based on the matching, a screen location corresponding to eye tracking information received at the optical sensor may be determined for subsequent eye tracking operations.

According to various embodiments, calibration eye tracking operations may involve making other types of comparisons. For example, a user may be asked to quickly glance between two or more screen locations to calibrate eye motion tracking. As another example, a user may be asked to exhibit one or more facial expressions to calibrate facial expression detection. As yet another example, a user may be asked to move or position his or her head to calibrate head location and/or orientation detection. As still another example, a user may be asked to blink, open, and/or close his or her eyes to calibrate blinking or eyelid aperture size detection. In particular embodiments, the specific operations performed when calibration eye tracking operations may be strategically determined based on factors such as the capabilities of the device, the type of eye activities being tracked, and the calibration information received via the optical sensor.

At 312, the interface is activated. The specific operations performed to activate the interface may depend on the type of interface being activated. According to various embodiments, activation of the interface may involve completing a boot up procedure for the device, presenting a webpage in a web browser, displaying an application on a display screen, loading a user interface within a currently running application, or any other operations for completing the activation or initiation process for an interface at the computing device.

FIG. 4 illustrates one example of a method for transmitting an eye tracking calibration interface to a client machine. As discussed with respect to operation 102 shown in FIG. 1, an eye tracking calibration interface may be provided to a computing device in various ways. In particular embodiments, the eye tracking calibration interface may be transmitted from a server in communication with the computing device via a network.

According to various embodiments, the eye tracking calibration may be performed in various locations. For example, the server may provide an eye tracking calibration interface for performing eye tracking calibration at the client machine. As another example, the server may provide an eye tracking calibration interface for transmitting eye tracking calibration information back to the server and performing the eye tracking calibration at the server. As yet another example, the server may provide an eye tracking calibration interface for performing eye tracking at another location, such as a different computing device in communication with the client machine.

At 402, a request to provide an eye tracking calibration interface to a client machine is received. According to various embodiments, the request may be received at a server in communication with the client machine. For instance, the request may be received at a web server, an application server, or any other type of server operable to receive a request from the client machine.

According to various embodiments, various types of requests may be received. For example, the request may be an HTTP request for a web page to be presented in a web browser. As another example, the request may be a download request for an application hosted at the server. As yet another example, the request may be a request for a dynamic interface to include in an application already running at the client machine, such as a content management application. Examples of content management applications are the media platforms available from MobiTV located in Emeryville, Calif.

At 404, hardware information for the client machine is identified. According to various embodiments, the hardware information may be any information related to the hardware capabilities of the client machine. For example, the hardware information may identify a device type of the client machine, a screen size or resolution of a display screen at the client machine, and/or a processor type or memory amount present at the client machine. As another example, the hardware information may identify the optical sensing abilities of the client machine. For instance, the hardware information may identify the type or capabilities of one or more optical sensors present at the client machine.

At 406, software information for the client machine is identified. According to various embodiments, the software information may be any information related to the types of applications and software capabilities available at the client machine. For instance, the software information may identify an operating system at the client machine, one or more applications running at the client machine, one or more application versions of applications running at the client machine, or any other information.

According to various embodiments, the hardware and/or software information may be identified in various ways. For example, in some cases the information may be transmitted from the client machine. As another example, the information may be associated with a device in settings for a user account. Then, he information may be retrieved from a storage location accessible to the server.

At 408, an eye tracking calibration interface is created for the client machine. According to various embodiments, the eye tracking calibration interface may be any configuration of a display screen for performing eye tracking during the startup of an operating system, webpage, application, or other user interface. For instance, an eye tracking calibration interface may designate one or more areas of the display screen as calibration areas. The eye tracking calibration interface may also include a message requesting the user to gaze at the calibration areas in order to calibrate eye tracking at the device.

According to various embodiments, various factors may affect the creation of the eye tracking calibration interface. For example, the eye tracking calibration interface may be created based on the type of hardware and/or software present at the device at which the eye tracking calibration is to be performed. As another example, the eye tracking calibration interface may be created based on the type of interface being activated at the client machine. As yet another example, the eye tracking calibration interface may be created based on the results of previous eye tracking calibration operations at the client machine. For instance, previous eye tracking calibrations may indicate a decreased need for a sophisticated calibration process in the future.

According to various embodiments, the eye tracking calibration interface may be created in response to the request from the client machine described with respect to operation 402. For instance, the eye tracking calibration interface may be incorporated into a webpage or an application.

According to various embodiments, the eye tracking calibration interface may not be created in response to the request from the client machine described with respect to operation 402. Instead, the server may retrieve an appropriate application file or files for transmission to the client machine. For example, the eye tracking calibration interface may already be incorporated into an application, such as an application requested for download by the client machine.

At 410, a determination is made as to whether to create additional eye tracking interfaces for the client machine. According to various embodiments, the determination made at operation 410 may be based upon various factors. For example, a more sophisticated client device may be sent additional eye tracking calibration interfaces for more detailed eye tracking calibration. As another example, a client device may be sent additional eye tracking calibration interfaces when calibration using a more limited set of interfaces results in insufficient data for calibrating eye tracking. As yet another example, a client device may be sent fewer calibration interfaces when eye tracking calibration has previously been performed at the client device. In this case, subsequent eye tracking procedures may be used to confirm or verify preexisting eye tracking calibration information.

In particular embodiments, a client device at which eye tracking is more difficult or complicated may be sent additional eye tracking calibration interfaces. For instance, eye tracking may be relatively simple when the user is operating a laptop since the user is likely to be located at a relatively fixed distance close to the laptop. At the same time, eye tracking may be relatively difficult when the user is operating a television since the user could be located anywhere within viewing distance of the television. In such situations, a more sophisticated eye tracking procedure may be required.

At 412, the eye tracking calibration interface is transmitted to the client machine. According to various embodiments, the way in which the eye tracking calibration interface is transmitted may depend at least in part on the type of interaction being performed between the server and the client machine, as discussed with respect to operation 402. For example, the eye tracking calibration interface may be transmitted as part of a webpage requested by the client machine. As another example, the eye tracking calibration interface may be transmitted as part of an application downloaded by the client machine.

FIG. 5 is a diagrammatic representation illustrating one example of a fragment or segment system 501 associated with a content server that may be used in a broadcast and unicast distribution network. Encoders 505 receive media data from satellite, content libraries, and other content sources and sends RTP multicast data to fragment writer 509. The encoders 505 also send session announcement protocol (SAP) announcements to SAP listener 521. According to various embodiments, the fragment writer 509 creates fragments for live streaming, and writes files to disk for recording. The fragment writer 509 receives RTP multicast streams from the encoders 505 and parses the streams to repackage the audio/video data as part of fragmented MPEG-4 files. When a new program starts, the fragment writer 509 creates a new MPEG-4 file on fragment storage and appends fragments. In particular embodiments, the fragment writer 509 supports live and/or DVR configurations.

The fragment server 511 provides the caching layer with fragments for clients. The design philosophy behind the client/server application programming interface (API) minimizes round trips and reduces complexity as much as possible when it comes to delivery of the media data to the client 515. The fragment server 511 provides live streams and/or DVR configurations.

The fragment controller 507 is connected to application servers 503 and controls the fragmentation of live channel streams. The fragmentation controller 507 optionally integrates guide data to drive the recordings for a global/network DVR. In particular embodiments, the fragment controller 507 embeds logic around the recording to simplify the fragment writer 509 component. According to various embodiments, the fragment controller 507 will run on the same host as the fragment writer 509. In particular embodiments, the fragment controller 507 instantiates instances of the fragment writer 509 and manages high availability.

According to various embodiments, the client 515 uses a media component that requests fragmented MPEG-4 files, allows trick-play, and manages bandwidth adaptation. The client communicates with the application services associated with HTTP proxy 513 to get guides and present the user with the recorded content available.

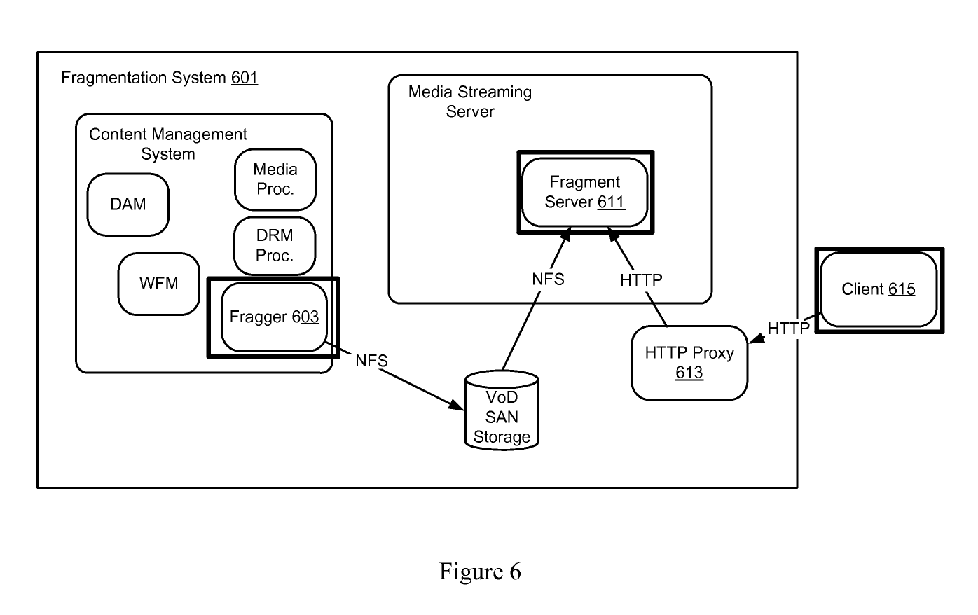

FIG. 6 illustrates one example of a fragmentation system 601 that can be used for video-on-demand (VoD) content. Fragger 603 takes an encoded video clip source. However, the commercial encoder does not create an output file with minimal object oriented framework (MOOF) headers and instead embeds all content headers in the movie file (MOOV). The fragger reads the input file and creates an alternate output that has been fragmented with MOOF headers, and extended with custom headers that optimize the experience and act as hints to servers.

The fragment server 611 provides the caching layer with fragments for clients. The design philosophy behind the client/server API minimizes round trips and reduces complexity as much as possible when it comes to delivery of the media data to the client 615. The fragment server 611 provides VoD content.

According to various embodiments, the client 615 uses a media component that requests fragmented MPEG-4 files, allows trick-play, and manages bandwidth adaptation. The client communicates with the application services associated with HTTP proxy 613 to get guides and present the user with the recorded content available.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A method comprising:
presenting a user interface activation screen for activating a user interface at a computing device, the user interface activation screen including an eye tracking calibration affordance configured for calibrating eye tracking at the computing device, the eye tracking calibration affordance being displayed at a designated location on the user interface activation screen;
receiving eye tracking information via an optical sensor at the computing device, the eye tracking information describing a state of one or both eyes of an individual located proximate to the computing device during activation of the affordance;
comparing the eye tracking information with the designated location to calibrate eye tracking at the computing device; and
activating the user interface.

2. The method recited in claim 1, wherein the eye tracking calibration affordance comprises a user input button activated when a determination is made that the individual's eyes are focused on the user input button.

3. The method recited in claim 1, wherein activating the user interface comprises an operation selected from the group consisting of: loading a website in a web browser displayed at the computing device, initiating an application on the computing device, and booting up the computing device.

4. The method recited in claim 1, the method further comprising:
based on the eye tracking calibration, performing eye tracking of the individual's eyes after the user interface is activated.

5. The method recited in claim 1, the method further comprising:
receiving information for creating the user interface activation screen from a remote server; and
transmitting the eye tracking information to the remote server.

6. The method recited in claim 1, wherein the eye tracking information identifies a screen location on which the eyes are focused.

7. The method recited in claim 6, wherein the eye tracking information identifies a time duration during which the eyes are focused in the identified direction.

8. The method recited in claim 1, wherein the eye tracking information comprises movement information, the movement information identifying a direction and a velocity of eye movement.

9. The method recited in claim 8, wherein the eye movement information also identifies an acceleration of eye movement.

10. A computing device comprising:
a display screen operable to present a user interface activation screen for activating a user interface at a computing device, the user interface activation screen including an eye tracking calibration affordance configured for calibrating eye tracking at the computing device, the eye tracking calibration affordance being displayed at a designated location on the user interface activation screen;
an optical sensor operable to receive eye tracking information describing a state of one or both eyes of an individual located proximate to the computing device during activation of the affordance;
memory operable to store the received eye tracking information; and
a processor configured to compare the eye tracking information with the designated location to calibrate eye tracking at the computing device and to activate the user interface.

11. The computing device recited in claim 10, wherein the eye tracking calibration affordance comprises a user input button activated when a determination is made that the individuals' eyes are focused on the user input button.

12. The computing device recited in claim 10, wherein activating the user interface comprises an operation selected from the group consisting of: loading a website in a web browser displayed on the display screen, initiating an application on the computing device, and booting up the computing device.

13. The computing device recited in claim 10, wherein the processor is further configured to:
perform eye tracking of the individual's eyes based on the eye tracking calibration after the user interface is activated.

14. The computing device recited in claim 10, the computing device further comprising a network interface operable to:
receive information for creating the user interface activation screen from a remote server, and
transmit the eye tracking information to the remote server.

15. The computing device recited in claim 10, wherein the eye tracking information identifies a screen location on which the eyes are focused.

16. The computing device recited in claim 10, wherein the eye tracking information identifies a time duration during which the eyes are focused in the identified direction.

17. One or more computer readable media having instructions stored thereon for performing a method, the method comprising:
presenting a user interface activation screen for activating a user interface at a computing device, the user interface activation screen including an eye tracking calibration affordance configured for calibrating eye tracking at the computing device, the eye tracking calibration affordance being displayed at a designated location on the user interface activation screen;
receiving eye tracking information via an optical sensor at the computing device, the eye tracking information describing a state of one or both eyes of an individual located proximate to the computing device during activation of the affordance;
comparing the eye tracking information with the designated location to calibrate eye tracking at the computing device; and
activating the user interface.

18. The one or more computer readable media recited in claim 17, wherein the eye tracking calibration affordance comprises a user input button activated when a determination is made that the individuals' eyes are focused on the user input button.

19. The one or more computer readable media recited in claim 17, wherein activating the user interface comprises an operation selected from the group consisting of: loading a website in a web browser displayed at the computing device, initiating an application on the computing device, and booting up the computing device.

20. The one or more computer readable media recited in claim 17, the method further comprising:
based on the eye tracking calibration, performing eye tracking of the individual's eyes after the user interface is activated.
